(19) United States
(12) Patent Application Publication
(10) Pub. No.: US 2015/0278022 A1
(43) Pub. Date: Oct. 1, 2015

(54) METHODS AND ARRANGEMENTS FOR HANDLING FILE REPAIR DURING MBMS OR eMBMS DELIVERY

(71) Applicant: TELEFONAKTIEBOLAGET L M ERICSSON (PUBL), Stockholm (SE)

(72) Inventors: Kun Chen, Shanghai (CN); Jie Ling, Shanghai (CN); Shiyuan Xiao, Shanghai (CN); Jinyang Xie, Shanghai (CN)

(73) Assignee: Telefonaktiebolaget L M Ericsson (publ), Stockholm (SE)

(21) Appl. No.: 14/438,445

(22) PCT Filed: Nov. 26, 2012
(86) PCT No.: PCT/SE2012/051301

§ 371 Date: Apr. 24, 2015

(30) Foreign Application Priority Data
Oct. 26, 2012 (CN) PCT/CN2012/083612

(51) Int. Cl. G06F 11/14; H04L 29/06; H04L 12/18

(52) U.S. Cl. CPC G06F 11/1412; H04L 12/18; H04L 65/1083; H04L 65/4076

(57) ABSTRACT

Methods for delivering user information via Multimedia Broadcast Multicast Services (MBMS) or enhanced Multimedia Broadcast Multicast Services (eMBMS) to user equipments capable of receiving this user information are disclosed. A method provides a file repair size threshold which indicates a maximum allowed file repair size to the user equipments. Another method is executable in a user equipment for determining whether or not to execute a fire repair request on the basis of a comparison of a required file repair and a file repair size threshold in case a file repair size threshold is available at the user equipment. Related user equipment and apparatuses capable of executing the methods are also disclosed.

### TECHNICAL FIELD

The present disclosure refers to methods for handling file repair demands in association with delivery of user information via MBMS or eMBMS and an apparatus and a user equipment for executing such methods.

### BACKGROUND

Multimedia Broadcast and Multicast Services (MBMS) is a type of broadcasting and multicasting service offered via cellular networks, such as e.g. Global system for Mobile communications (GSM) and, Universal Mobile Telecommunications System (UMTS), while Enhanced MBMS (eMBMS) is a corresponding type of broadcasting and multicasting service which is used to denominate MBMS in Evolved Packet Systems, including Evolved Universal Terrestrial Radio Access Network (E-UTRAN) for Long Term Evolution (LTE) cellular networks and UTRAN for e.g. Universal UMTS cellular networks.

A typical scenario where MBMS or eMBMS is used is for delivering sport games video content to a large number of mobile phones, e.g. in a sport stadium or any other large arena, where the system can use the File Delivery over Unidirectional Transport (FLUTE) protocol to deliver Live TV content to user equipments (UEs), such as e.g. mobile phones. Media Segments provided e.g. according to Apple's HTTP Live Streaming (HLS) Protocol, or according to the DASH standard are examples of media segments which may be delivered as files over MBMS/eMBMS Download.

Another scenario applicable for MBMS or eMBMS is distribution of Android update. MBMS or eMBMS systems can use the FLUTE protocol to deliver popular files, such as e.g. Android update, YouTube clip preloading or major news events to UEs.

In MBMS/eMBMS, the user services are described in the data model 100 as illustrated in FIG. 1, which is defined in 3GPP TS 26.346. From hereinafter throughout this document mentioning of use of MBMS is to include use of MBMS, as well as use of eMBMS.

User Service Bundle Description 101 is used for grouping user services, and may contain one or more User Service Description (USD), also referred to as USD instance 102. It may also refer to a single Forward Error Correction (FEC) Repair Stream Description 103.

The USD instance 102 contains one or more Delivery Method descriptions 104, which is used to describe for a UE how a service is to be delivered to the UE. A Delivery Method description 104 refers to a Session Description instance 105, which describes the delivery related parameters to be considered during a session delivery. An Associated Delivery Procedure Description 106 may also be referenced by a Delivery Method description 104 to provide a complementary delivery method for a respective service, which may be used in case a service delivery fails. One example of a file complementary delivery method which is applicable in MBMS is the file repair method. The Delivery Method description 104 may also reference to a Security Description 107, which is used for providing the service protection information to UEs.

One USD instance 102 may also include at most one schedule instance 108. If included, the schedule instance 108 shall refer to one schedule description instance 109. A UE wanting to use MBMS for a user service can expect to receive user information distributed via MBMS during the time periods described in the schedule description instance 109. In the case of a file download service, the schedule description instance 109 may also include a file transmission schedule for file objects associated with the user service. The UE may select which files to receive based on the file transmission schedules provided in the schedule description instance 109.

In order for the UE to be able to repair a certain amount of errors that has occurred during the MBMS transmission, MBMS makes use of Forward Error Correction, FEC, technology. However, FEC cannot guarantee 100% reliability for file delivery so e.g. in case there are too many errors, the UE may not be capable of recovering missing data by using FEC. On such occasions the UE may also request a file repair procedure provided via MBMS, in order to be able to access un-received symbols and to be able to recover user information.

Therefore, two other types of error recovery methods are defined and usable after an MBMS transmission has ended.

By applying the Point-to-Point (PTP) File Repair method, a UE can fetch missing data using The Hypertext Transfer Protocol (HTTP). The Point-to-Multipoint (PTM) File Repair method allows a Broadcast Multicast Service Center (BM-SC) to send symbols which have been identified by the UE as missing during decoding after the actual MBMS data transfer has finished.

An example of use of MBMS and file repair according to the prior art will now be described in further detail with reference to FIG. 2. It is to be understood that FIG. 2 is a simplified schematic illustration of how user information, i.e. any kind of media content or data can be distributed to a plurality of UEs via an MBMS network, where, instead of showing a complete communications network and nodes building up such a network, the network of FIG. 2 is represented by a gateway which is accessible to a BM-SC. It is also to be understood that, although a plurality of UEs are typically receiving an MBMS session, FIG. 2 comprise only one UE for simplicity reasons. For the same reason, even though a plurality of file repair servers may be used in a typical MBMS system, only one file repair server is shown in the Fig.

In a first step 1:1, a USD instance is transmitted from a BM-SC 200 to UE 202 in order to provide MBMS session information to the UE, i.e. to provide information necessary for the UE to be able to receive a certain session. In a next step 1:2, the BM-SC 200 is initiating the session, here illustrated as establishment of a connection with a Gateway 201. The BM-SC 200 then need to transmit one or more FDT instances, comprising file delivery information, such as e.g. file size, location, MIME type to the UE. In the present example, BM-SC 200 transmits a first FDT instance #x to a UE 202, as indicated with a next step 1:3, thereby providing instructions for UE 200 on how to receive user information associated with the initiated MBMS session, followed by transmitting one or more files of the actual user information to UE 202, as indicated with another, subsequent step 1:4. The described procedure is repeated for further FDT instances and associated files, here illustrated with subsequent steps 1:5 and 1:6 respectively.

After the broadcast has stopped, as indicated with step 1:7a, UE 202 recognizes that more symbols have been lost than what can be handled by FEC, to recover the user data. A typical scenario may e.g. be when the size of the broadcasted file is very big, e.g. 1Gbyte in size, and the packet loss rate is also relatively high, in relation to the FEC redundancy level. Therefore, it is determined at UE 202 that file repair is required, as indicated with step 1:7b. After a wait back-off time has terminated, as indicated in step 1:8, UE 202 sends a request, here for PTP File repair, to a file repair server 203, as indicate in a next step 1:9. In a final step 1:10, the file repair server 203 responds by providing file repair to UE 202.

In some situations the UE may e.g. start receiving the broadcast delivery very late or the UE may be involved in a phone call or another application or may even experience a power off, which may result in that the UE miss major broadcast delivery timeslots, such that the UE receiver will need to request a major part of the file from a file repair server.

If the FEC redundancy level is e.g. 15% and the UEs packet loss rate is 25%, the UE will need at least 1Gbyte*0.25*0.15=100 Mbyte of repair symbols for handling such a case. If many UEs experience similar file repair demands simultaneously there will be a severe risk of overload at the file repair server.

### SUMMARY

An object of the present disclosure is to address the problem mentioned above.

According to a first aspect, a UE capable of receiving user information provided via Multimedia Broadcast Multicast Services, MBMS, or enhanced Multimedia Broadcast Multicast Services, eMBMS, is provided, which comprises a receiver configured to receive an USD instance and associated user information in a session transmitted via MBMS or eMBMS and a determining unit which is configured to respond to recognizing a request for file repair of missing symbols associated with the session by determining whether the USD instance contained a file repair size threshold, indicative of a maximum allowed repair size, and by restricting initiation of file repair on the basis of a comparison of the size of the requested file repair and the stored file repair threshold, in case a file repair size threshold is contained in the USD instance.

More specifically, the determining unit is configured to restrict initiation of file repair, in case a file repair size threshold was contained in the USD instance and in case the size of the requested file repair exceeds the stored file repair threshold.

The storing unit is configured to store a received USD instance in a storing unit of the UE and to determine whether the USD instance contained a file repair size threshold by checking the content of the stored USD instance.

The determining unit may be configured to restrict initiation of file repair by prohibiting initiation of file repair, in case a file repair size threshold is available to the UE.

Typically the determining unit is further configured to determine whether there is at least one alternative method available for the UE and the session to retrieve the missing symbols and to initiate an alternative method, in case such an alternative method is available.

According to a first embodiment, the determining unit is configured to determine that there is at least one broadcast delivery timeslot available for the session, and to initiate resumed reception of the session, via the receiver, via the at least one broadcast delivery timeslot, in case initiation of file repair is restricted for the session.

According to a second embodiment, the determining unit is configured to determine that unicast is available for the session, and of initiating resumed reception, via the receiver, of the session via unicast, in case initiation of file repair is restricted for the session.

According to a second aspect an apparatus at a Broadcast Multicast Service Center, BM-SC, capable of transmitting user information to user equipments, UEs, via Multimedia MBMS, or eMBMS is provided comprising: a determining unit configured to determine whether or not to apply a restricted use of a file repair for a session, wherein: a selecting unit is configured to select a file repair size threshold, indicative of a maximum allowed file repair size and to insert the selected file repair size threshold into a User Service Description, USD instance, associated with the session, and a transmitter is configured to transmit the USD instance to the UEs, in case restricted use of file repair is to be applied, thereby enabling any of the UEs to apply a restricted use of file repair for user information associated with the USD instance, based on a comparison of a size of a requested file repair and the file repair size threshold.

The file repair size threshold may be provided to the UEs in different ways.

According to a first embodiment, the selecting unit is configured to insert the file repair size threshold into a schedule description metadata fragment of the USD instance, while according to a second embodiment inserting unit is instead configured to insert the file repair size threshold into an Associated Delivery Procedure Description, ADPD metadata fragment of the USD instance.

The selecting unit is also configured to select an updated file repair size threshold, which is inserted into an updated USD instance, and transmitted via the transmitter, in case it has been determined by the selecting unit that the file repair size threshold should be updated for the session.

The determining unit is configured to initiate transmission of an updated USD instance, indicative of no file repair size threshold, via the transmitter, in case it has determined that no restricted use of file repair is to be applied for the session.

The determining unit may be configured to determine to update the file repair size threshold on the basis of experienced and/or estimated transmission conditions, such that restriction of use of a file repair method is used dynamically only when required.

According to a third aspect a method executable in a UE, capable of receiving user information via MBMS, or eMBMS, i.e. a UE, such as the one described above, is provided. Such a method comprises: receiving, in a session, a User Service Description, USD, instance, and associated user information, transmitted via MBMS or eMBMS; recognizing a request for file repair of missing symbols associated with the session; determining whether the USD instance contained a file repair size threshold, indicative of a maximum allowed file repair size, and restricting initiation of file repair on the basis of a comparison of the recognized file repair size and the stored file repair size threshold, in case a file repair size threshold is contained in the USD instance.

More specifically, to restrict initiation of file repair is determined in case a file repair size threshold is contained in the USD instance and in case the size of the requested file repair exceeds the stored file repair threshold.

A received USD instance is stored in a storing unit of the UE, and the determining step comprises determining whether the USD instance contains a file repair size threshold by checking the content of the stored USD instance.

The restriction of the initiation of file repair typically comprises prohibiting initiation of file repair in case the recognized file repair size exceeds the file repair size threshold.

Typically a decision to restrict initiation of file repair is executed together with determining whether there is at least one alternative method available for the UE and the session to retrieve the missing symbols, and initiating an alternative method, in case such an alternative method is available.

According to a first embodiment, it is determined whether there is at least one broadcast delivery timeslot available for the UE and the session to retrieve the missing symbols and resumed reception of the session is initiated via the at least one broadcast delivery timeslot, in case initiation of file repair is restricted for the session.

According to a second embodiment, it is determined that unicast is available for the session, and resumed reception of the session is initiated via unicast, in case initiation of file repair is restricted for the session.

According to a fourth aspect a computer program comprising computer program code is provided where the computer program code is configured such that when it is executed by a processor it causes the processor to implement the method executed on the UE as described above.

According to a fifth aspect a computer program product is provided which comprises a computer readable storage medium, having the computer program having the computer program mentioned above embodied therein.

According to a sixth aspect, a method executable in an apparatus at a BM-SC capable of transmitting user information via, MBMS, or eMBMS to UEs capable of receiving the user information is provided. The method comprise: determining whether or not to apply a restricted use of a file repair for a session, wherein in case restricted use of file repair is to be applied for the session, the method further comprise: selecting a file repair size threshold, indicative of a maximum allowed file repair size; inserting the selected file repair size threshold into a User Service Description, USD instance, associated with the session, and transmitting the USD instance to the UEs, in case restricted use of file repair is to be applied, thereby enabling any of the UEs to apply a restricted use of file repair for user information associated with the USD instance, based on a comparison of a size of a requested file repair and the file repair size threshold.

According to a first embodiment the file repair size threshold is inserted into a schedule description metadata fragment of the USD instance, while according to a second embodiment the file repair size threshold is instead inserted into an Associated Delivery Procedure Description, ADPD metadata fragment of the USD instance.

Upon determining that an updating of the file repair size threshold is required it may be updated and transmitted by repeating the steps mentioned above.

In case the file repair size threshold is to be disabled an updated USD instance, indicative of no file repair size threshold may be assembling and transmitting, in case it has determined that no restricted use of file repair is to be applied for the session.

According to one embodiment, selection of the file repair size threshold may be executed on the basis of experienced and/or estimated transmission conditions, which typically may be available at the network.

According to a seventh aspect, a computer program comprising computer program code, where the computer program code is being configured such that when executed by a processor it causes the processor to implement the method executed on the apparatus as described above.

According to a eights aspect, a computer program product is provided which comprising a computer readable storage medium, having the computer program mentioned above embodied therein.

### BRIEF DESCRIPTION OF THE DRAWINGS

Different embodiments will now be described in more detail in relation to the accompanying drawings, in which:

FIG. 1 is a schematic MBMS description data model.

FIG. 2 is a simplified signaling scheme illustrating an MBMS session executed according to the prior art.

FIG. 3 is a flow chart illustrating a method for preparing for and delivering an USD instance.

FIG. 4 is another flowchart extending the flowchart of FIG. 3 by recognizing a requirement for an USD instance update according to a first scenario.

FIG. 5 is yet another flowchart further extending the flowchart of FIG. 3 by recognizing a requirement for an USD instance update according to a second scenario.

FIG. 6 is a flow chart illustrating a method for handling a received USD instance and a required file repair based on the content of the USD instance.

FIG. 7 is a simplified block scheme of an apparatus at a BM-SC for preparing and transmitting a file repair size threshold, according to a first embodiment.

FIG. 8 is a simplified block scheme of a UE according to a first embodiment.

FIG. 9 is a simplified block scheme of an apparatus at a BM-SC according to a second embodiment.

FIG. 10 is a simplified block scheme of a UE according to a second embodiment.

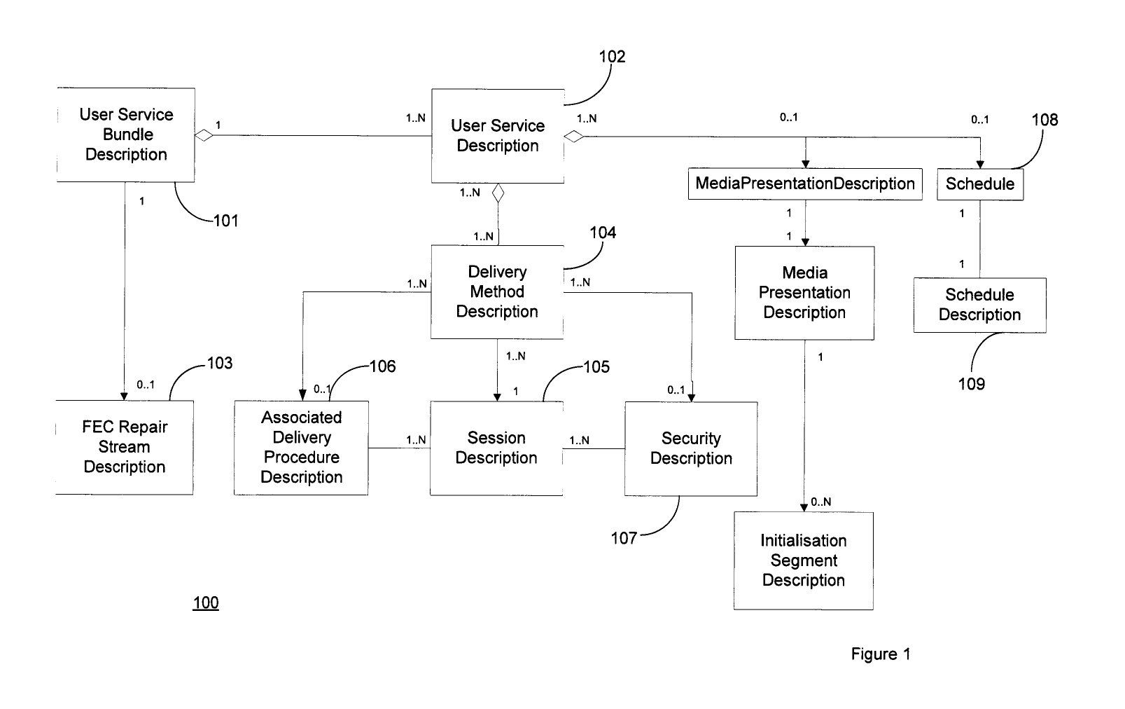

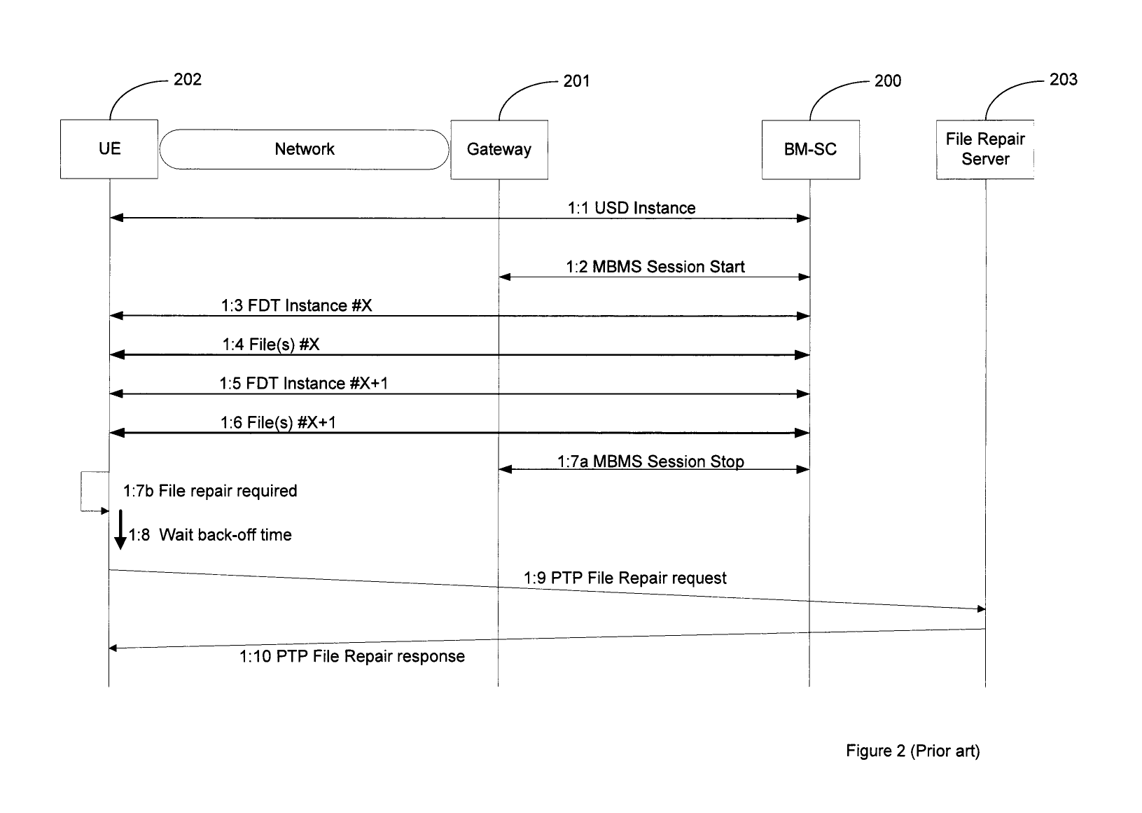

### DETAILED DESCRIPTION

The MBMS Service Layer specifications does not define any combination or sequence of any of the file repair methods described above. Therefore there is a demand for an alternative to applying a file repair method when conditions for successful file repair are found to be unsatisfactory.

Briefly described, methods, and apparatus capable of executing the suggested methods, are provided for enabling a UE receiving user information via MBMS to apply conditional restrictions of use of file repair, such that only when conditions so permit shall the UE be entitled to apply file repair for acquiring missing symbols. Typically, a UE applying the suggested file repair restriction method will restrict use of file repair of user information distributed via MBMS when conditions for achieving a successful file repair are unsatisfactory, and instead apply at least one alternative way of retrieving the required data.

More specifically, an attribute, constituting a file repair size threshold, indicating a maximum allowed file repair size is prepared at a service BM-SC, or any other apparatus having corresponding functionality, and distributed to one or more MBMS enabled UEs. From hereinafter the MBMS distributing entity will be referred to as a BM-SC. Each UE receiving a distributed file repair size threshold will be able to respond to a file repair request by comparing the size of the requested file repair to the file repair threshold and, in case the size of the requested file repair exceeds the file repair size threshold a restricted use of file repair is to be applied, typically by prohibiting the UE to request file repair for the respective session. Once a change of the file repair size threshold is determined at the BM-SC an updated file repair size threshold is distributed to the UEs. Thereby, each UE will always use the most recently updated file repair size threshold, in case there is any available, and the file repair size threshold may also be updated during an ongoing session.

By using the suggested threshold, a BM-SC will be able to, to at least some extend, control the maximum file repair bandwidth usage based on the size of the distributed files and, as a consequence, be able to prevent a unicast flood according to a predefined traffic model. By way of example, file repair may e.g. be prohibited if it is determined that after an MBMS session, a demand for file repair exceeds the file repair size threshold, which is set to 20 Mbyte.

By using the suggested threshold, a MBMS enabled UE can discard a current broadcast delivery at an early stage, e.g. if the current packet loss already exceeds a maximum file repair size. The MBMS enabled UE may in such an occasion instead select another, alternative distribution method which is available to the UE, thereby limiting the risk if battery drainage, excessive delays and also, from an operators point of view, excessive traffic in the network.

From hereinafter a UE is to be construed as meaning an eMBMS and/or MBMS enabled UE, i.e. a UE comprising a client which is capable of handling user information or any type of data transmitted to the UE via either eMBMS or MBMS.

In a typical scenario, a UE applying the suggested threshold will, instead of requesting file repair when such an option is restricted, apply an alternative way of acquiring the missing content. This may be arranged such that the BM-SC distributes a file repair size threshold to the UEs only when there is at least one alternative way of acquiring missing user information available for the UEs.

The new file repair size threshold is defined as a new attribute which may be provided to an USD instance in different alternative ways.

According to a first embodiment a file repair size threshold may be added as a new attribute into the USD instance, in a schedule fragment. Such a new attribute can e.g. be implemented into the 3GPP 26.346 standard as indicated below where the bold text indicates the added information:

<?xml version=″1.0″ encoding=″UTF-8″?>
<xs:schema xmlns=″urn:3gpp:metadata:2011:MBMS:scheduleDescription″
xmlns:xs=″http://www.w3.org/2001/XMLSchema″
xmlns:r11=″urn:3gpp:metadata:2012:MBMS:scheduleDescription″

xmlns:sv=″urn:3gpp:metadata:2009:MBMS:schemaVersion″
targetNamespace=″urn:3gpp:metadata:2011:MBMS:scheduleDescription″

elementFormDefault=″qualified″

version=″2″>

<xs:import schemaLocation=″Schedule-Rel-11-schema-snippet.xsd″
namespace=″urn:3gpp:metadata:2012:MBMS:scheduleDescription″/>
<xs:import schemaLocation=″schema-version.xsd″
namespace=″urn:3gpp:metadata:2009:MBMS:schemaVersion″/>
<xs:complexType name=″scheduleDescriptionType″>

<xs:sequence>
<xs:element ref=″sv:schemaVersion″/>

<xs:element name=″serviceSchedule″ maxOccurs=″unbounded″>
<xs:complexType>
<xs:sequence>
<xs:element name=″sessionSchedule″ type=″reoccurenceStartStopType″

minOccurs=″0″ maxOccurs=″unbounded″/>

<xs:element name=″sessionScheduleOverride″ minOccurs=″0″

maxOccurs=″unbounded″>

```
<xs:complexType>
<xs:sequence minOccurs=″0″>
<xs:element name=″start″ type=″xs:dateTime″/>
<xs:element name=″stop″ type=″xs:dateTime″/>
</xs:sequence>
<xs:attribute name=″index″ type=″xs:unsignedInt″ use=″required″/>
<xs:attribute name=″cancelled″ type=″xs:boolean″/>
  </xs:complexType>
</xs:element>
<xs:element name=″fileSchedule″ minOccurs=″0″ maxOccurs=″unbounded″>
<xs:complexType>
  <xs:sequence>
```

```
<xs:element name=″fileURI″>
  <xs:complexType>
  <xs:simpleContent>
```

<xs:extension base=″xs:anyURI″>
<xs:attribute name=″cancelled″ type=″xs:boolean″/>
</xs:extension>

```
  </xs:simpleContent>
  </xs:complexType>
</xs:element>
  <xs:element name=”maximumRepairSize” type=”xs:unsignedInt”
```

use=”optional”/>

<xs:element name=″deliveryInfo″ minOccurs=″0″ maxOccurs=″unbounded″>

| <xs:complexType> | |
|---|---|
| <xs: attribute name=″start″ type=″xs:dateTime″/> | |
| <xs:attribute name=″end″ type=″xs:dateTime″/> | <xs:anyAttribute |

processContents=″skip″/>

| </xs:complexType | |
|---|---|
| </xs:element> | <xs:any |

namespace=″##other″ processContents=″lax″ minOccurs=″0″ maxOccurs=″unbounded″/

</xs:sequence>

```
  <xs:attribute ref=″r11: session Id″ use=″optional″/>
  <xs:attribute ref=″r11:fileMD5″ use=″optional″/>
  <xs:anyAttribute processContents=″skip″/>
```

| | |
|---|---|
| </xs:complexType> | </xs:element> |

...............
</xs:schema>

Where “maximumRepairSize” represents the file repair size threshold.

According to a second, alternative embodiment, the new attribute may instead be added into an ADPD fragment, where the new attribute is defined as a child of an ADPD metadata fragment, which can be implemented in the 3GPP 26.346 standard e.g. as suggested below, where, again, the added information is indicated in bold text:

<?xml version=″1.0″ encoding=″UTF-8″?>
<xs:schema

xmlns=″urn:3gpp:metadata:2005:MBMS:associatedProcedure″
xmlns:xs=″http://www.w3.org/2001/XMLSchema″
targetNamespace=″urn:3gpp:metadata:2005:MBMS:associatedProcedure″
elementFormDefault=″qualified″>
<xs:element name=″associatedProcedureDescription″

type=″associatedProcedureType″/>

<xs:complexType name=″associatedProcedureType″>

<xs:sequence>

<xs:element name=″postFileRepair″ type=″basicProcedureType″

minOccurs=″0″/>

<xs:element name=″bmFileRepair″ type=″bmFileRepairType″

minOccurs=″0″/>

<xs:element name=″postReceptionReport″ type=″reportProcedureType″

minOccurs=″0″/>

<xs:any namespace=″##other″ processContents=″skip″ minOccurs=″0″

maxOccurs=″unbounded″/>

</xs:sequence>

</xs:complexType>
<xs:complexType name=″basicProcedureType″>

<xs:sequence>

<xs:element name=″serviceURI″ type=″xs:anyURI″

maxOccurs=″unbounded″/>

</xs:sequence>
<xs:attribute name=″offsetTime″ type=″xs:unsignedLong″ use=″optional″/>
<xs:attribute name=″randomTimePeriod″ type=″xs:unsignedLong″

use=″required″/>

</xs:complexType>
<xs:complexType name=″bmFileRepairType″>

<xs:attribute name=″sessionDescriptionURI″ type=″xs:anyURI″ use=″required″/>

<xs:attribute name=”maximumRepairSize” type=”xs:unsignedInt”

use=”optional”/>

</xs:complexType>
<xs:complexType name=″reportProcedureType″>

<xs:complexContent>

<xs: extension base=″basicProcedureType″>

<xs:attribute name=″samplePercentage″ type=″xs:decimal″ use=″optional″

default=″100″/>

<xs:attribute name=″forceTimeIndependence″ type=″xs:boolean″

use=″optional″

default=″false″/>

<xs:attribute name=″reportType″ type=″xs:string″ use=″optional″/>

</xs:extension>

</xs:complexContent>

</xs:complexType>

</xs:schema>

Also in this example the attribute is denoted “maximumRepairSize”.

The file repair size threshold will be an optional attribute, which will be used by UEs which are configured for applying restricted file repair use, while UEs which are not applying this feature will ignore such a threshold when provided in a USD instance. Thereby full backwards compatibility will be provided.

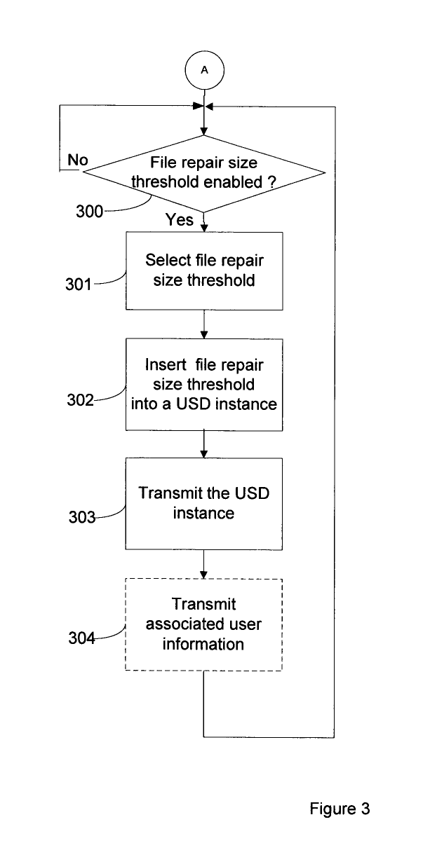

A method executable in a BM-SC for enabling a UE to apply restrictive use of file repair when conditions so require will now be described in further detail with reference to FIG. 3.

The method as described in FIG. 3 can be executed whenever there is a need for distributing a new or updated USD instance associated with user information, distributed to UEs via an MBMS session, under condition that the file repair feature is enabled, i.e. made available to the UEs. Typically, the suggested file repair restriction method is initiated at the BM-SC upon distribution of an MBMS session represented by a large file which is to be sent when resources for transmitting the session are known to be heavily loaded, e.g. during an event which is attracting a large number of subscribers. The threshold can be applied e.g. when the operator has already applied the unicast delivery together with the broadcast delivery or where there are several following broadcast schedules planned for the same large file. The BM-SC may make use of any type of information on experienced and/or estimated transmission conditions for determining when and how to apply the suggested file repair restricting mechanism.

In a first step 300 it is determined whether or not a file repair size threshold is to be enabled for a respective session. More specifically, the BM-SC makes a decision as to whether or not a restrictive use of file repair shall be applied for a specific session.

In a next step 301 a file repair size threshold, indicative of a maximum allowed file repair size, is selected. How this threshold is selected will typically depend on the circumstances which triggered the method in the first place, such that e.g. as expected traffic load increases, the applied threshold decreases. If required file repair sizes are found to be close to the original file sizes which give rise to requests for a major part of a file, leading to inefficient FEC decoding in order to recover the original file, an increase of the file repair size threshold may be required. Details on how to come to such a conclusion are left out of this document, since real time measures on current traffic load situation, as well as predicting tools for predicting expected upcoming sever traffic load situations are well known to and commonly used by the skilled person.

Once the file repair size threshold to be applied has been determined, the determined file repair size threshold is inserted into a USD instance associated with the session, as indicated in step 302. The file repair size threshold may e.g. be inserted into a fragment according to any of the alternative embodiments suggested above, i.e. inserted into a schedule description metadata fragment of the USD instance, or into an, ADPD metadata fragment of the USD instance, or in any other way, as long as the threshold can be accessed and interpreted by a receiving UE.

In a next step 303, the USD instance is provided, i.e. transmitted, to the UEs in accordance with a known USD distribution procedure, such that any UE receiving the USD instance can use the file repair size threshold to restrict use of file repair on the session associated with the USD instance by comparing a required file repair size, identified from a fire repair request, with the most recently received file repair size threshold.

Once the process for distributing the USD instance has been executed, as described above, the BM-SC may, at any time, transmit user information associated with the USD instance, in a conventional manner, as indicated in a step 304, and a UE, having received the USD instance, can receive and interpret the user information, on the basis of content of the USD instance. Alternatively, the associated user information may be transmitted from another MBMS enabled entity.

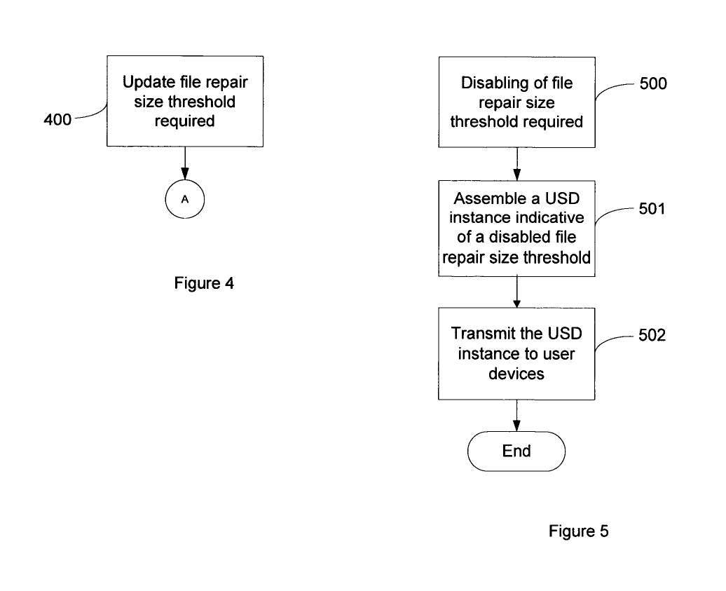

The file repair size threshold may be updated, not only prior to transmission of a session, but also at any time during transmission of the session, e.g. in response to rapidly changed transmission load conditions, wherein the method described above is repeated by determining a new file repair size threshold and transmitting the updated threshold in a new USD instance. This is illustrated with step 400 in FIG. 4, which is followed by the steps of FIG. 3.

If it is determined that no file repair size threshold is to be applied for a session, i.e. any file repair method available at the UEs is to be applied without any restrictions for the session, the same procedure as described above may be applied, but instead of indicating a file repair size threshold the USD instance is instead updated such that it is indicating that no file repair size threshold is to be applied, or that the file repair size threshold will be disabled, e.g. by providing an updated USD instance without any file repair size threshold, i.e. a conventional USD instance. Such a procedure may be executed according to FIG. 5, where in a first step 500 it is determined that disabling of a previously announced file repair size threshold is required, which triggers the assembling of an updated USD instance, indicating a disabled file repair size threshold, as indicated in step 501, followed by providing, i.e. transmitting the USD instance, to UEs, as indicated in a final step 502. Alternatively, an updated file repair size threshold is set, such that it is interpreted by a receiving UE as an unlimited threshold, which does in practice never have to be compared to a relevant file repair size.

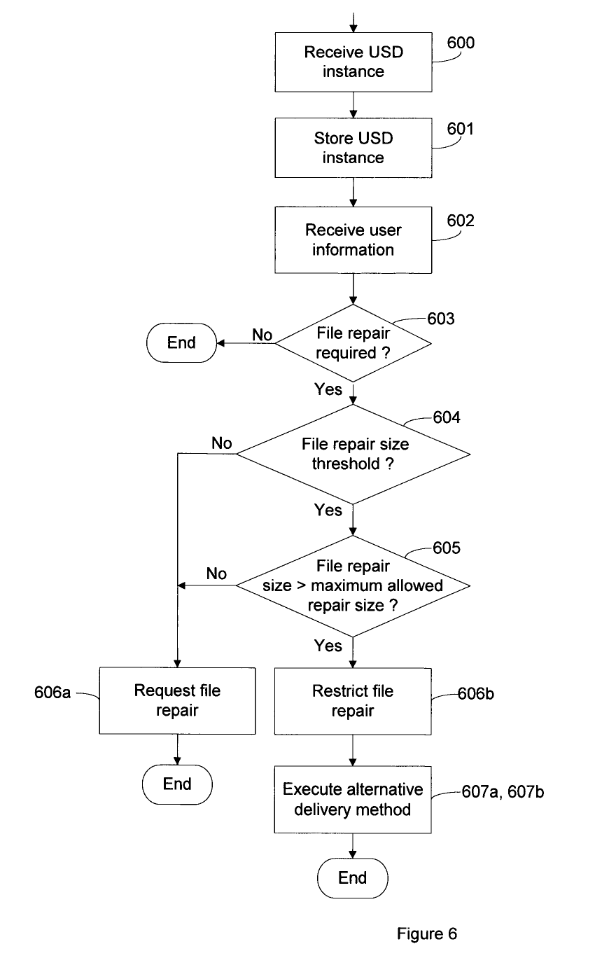

If the method described above is executed in a communication network adapted therefore, a UE receiving an USD instance will be triggered to execute a corresponding method in order to handle the file repair size threshold accordingly. Therefore, such a method will be described in further detail below, with reference to FIG. 6.

FIG. 6 describes a method which can be executed by any UE which is capable of receiving user information via MBMS, which is capable of applying a file repair method and which is also capable of recognizing and handling a file repair size threshold, as described herein.

As indicated in the initial step 600 of FIG. 6, the method is initiated by receiving a USD instance transmitted from a BM-SC, or any other transmitting entity having corresponding capabilities.

As indicated in a subsequent step 601 the received USD instance is then stored in a storage unit of the UE, such that the content of the USD instance can later be retrieved, e.g. in association with recognizing a file repair request.

Once the UE has received a USD instance, it will be capable of handling user information received in a session associated with the USD instance, as indicated in another step 602. The user information is typically transmitted from the transmitting entity which transmitted the USD instance, i.e. the BM-SC, but may alternatively be transmitted from another transmitting entity, as long as the user information is associated with the USD instance, i.e. the user information can be interpreted and handled by a UE on the basis of content in the USD instance.

If it is determined in subsequent step 603 that the received user information can be handled without requiring any file repair method, the file repair restricting method is terminated, typically together with the mentioned successfully received session. However, if it is instead determined that file repair is requested at the UE, i.e. according to conditions set up for that purpose at the UE, a request for file repair is identified, after which the described method continues by determining whether there is a file repair size threshold stored at the UE, i.e. if a file repair size threshold is enabled at the UE for the initiated session.

In case it is determined in step 604 that no file repair size threshold is available at the UE, the UE should handle any file repair request in a conventional manner, as indicated in step 606a, and the initiated process continues by executing the requested file repair method according to well known procedures.

If, on the other hand, there is a file repair size threshold stored at the UE, this threshold is considered as a threshold which is valid for the ongoing session and the file repair size threshold is compared to size of the requested file repair, i.e. the amount of data, represented by missing symbols, indicated e.g. in bytes, which is requested by the file repair request, as indicated in step 605.

If, in step 605, it is determined that the size of the requested file repair does not exceed the file repair size threshold, the procedure continues by executing the requested file repair procedure according to known procedures, while if instead the size of the requested file repair do exceed the file repair size threshold, a process for restricting file repair use is triggered, as indicated with step 606b. Typically, restriction of file repair is executed by prohibiting use of the file repair process for the session, but restricting may alternatively result in any type of limiting file repair use.

Although the described method may be applied also when there is no alternative way of acquiring missing data associated with transmitted user information, the described file repair size threshold is typically only applied if there is at least one alternative way of acquiring the user information available for the UE. In other words, restriction of use of file repair should typically only be applied when there is an alternative way of accessing the user information which results e.g. in less load on the network, less delay, less battery drainage, or gives any other gain compared to use of a file repair method.

According to a first alternative embodiment, which is represented by step 607a in FIG. 6 the UE is capable of determining, e.g. on the basis of content of the USD instance, that there is at least one broadcast delivery timeslot available for the ongoing, session, and receiving at least parts of the user information by resuming reception via one or more broadcast delivery timeslots.

According to a second alternative embodiment, which is represented by step 607b in FIG. 6, such a decision does instead trigger switching of the session to unicast reception and resuming reception of the user information via unicast.

Although the UE described above apply the file repair size threshold whenever the conditions stated above are all fulfilled, the UE may alternatively also be provided with the option of cancelling and resuming file repair restriction whenever required. Such an option may e.g. be provided as an automated option or a manually entered option.

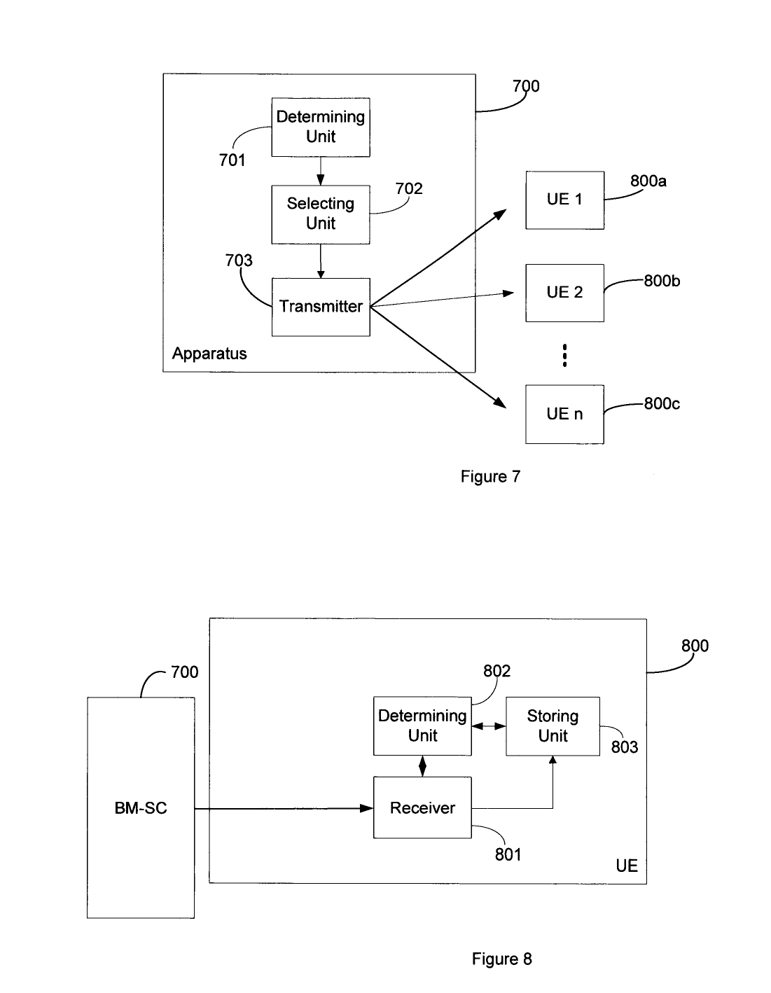

An apparatus, typically forming part of a BM-SC, or any other type of entity which is capable of transmitting using MBMS, i.e. which is capable of acting as a BM-SC, and which is capable of executing a method for providing an USD instance with a file repair size threshold as described above will now be described in further detail with reference to the simplified block scheme of FIG. 7. The described apparatus may be used in any type of communication network which is configured to provide MBMS, such as e.g. any one or a combination of LTE-SAE (Long Term Evolution-System Architecture Evolution), W-CDMA (Wideband Code Division Multiplex), EDGE (Enhanced Data Rates for GSM (Global System for Mobile communication) Evolution), GPRS (General Packet Radio Service), CDMA2000 (Code Division Multiple Access 2000), or any other current or future wireless network, such as LTE-Advanced, as long as the principles described hereinafter are applicable.

The apparatus 700 of FIG. 7 is capable of delivering user information to any UE 800a,800b,800c, which is capable of receiving user information via MBMS. The apparatus 700 comprises a determining unit 701 operatively connected to a selecting unit 702, where the determining unit 701 is configured to determine whether or not a file repair size threshold is enabled for a session. If it is determined that file repair threshold should be enabled, the selecting unit 702, is configured to select a file repair size threshold, which is indicating a maximum allowed file repair size, and to insert the selected file repair size threshold into a USD instance. In the present embodiment, the selecting unit 702 is operatively connected to a transmitter 703 which is configured to transmit the USD via MBMS. Although not shown, the apparatus 700 typically also comprises a storing unit.

According to a first embodiment, the selecting unit 702 is configured to insert the file repair size threshold into a schedule description metadata fragment of the USD instance, while according to a second embodiment the selecting unit 702 is instead configured to insert the file repair threshold into an ADPD metadata fragment of the USD instance. Alternatively the apparatus 700 may be configured to apply any of the suggested embodiments depending on present configuration or setting.

The determining unit 701 can be configured to determine to disable use of a file repair size threshold, e.g. based on changing conditions e.g. based on the network load, by instructing the selecting unit 702 to set up an updated USD instance which is indicative of no file repair size threshold, i.e. it indicates to a UE that no file repair size threshold is to be applied, and by distributing the updated USD instance via transmitter 703. Once the USD instance has been distributed, the apparatus 700 is configured to distribute associated user information via MBMS in a conventional manner. Any of or both of the determining unit 701 and the selecting unit 702 may be configured such that they have access to measured and/or predicted data which is indicative e.g. of the network traffic load, such that their decisions can be based on such data.

The determining unit 701 can also be configured to determine to update the file repair size threshold, wherein the selecting unit 702 selects a new threshold which is inserted into an updated USD instance by the inserting unit 703, whereafter an updated USD instance, indicative of the updated file repair size threshold is transmitted to the UEs via transmitter 704, also during an ongoing session. The described units are configured to execute the updating or the enabling of the file repair size threshold on a per service or session basis, i.e. a transmitted file repair size threshold will be valid for the duration of a service/session, or until an updated file repair size threshold is transmitted from the apparatus 700.

A UE configured to receive user information sent via MBMS and handle a file repair size threshold, as described above, will now be described according to one embodiment, with reference to the simplified block scheme of FIG. 8. UE is here to include e.g. a mobile phone a laptop a PC a Set Top Box, a TV, or any type of fixed or mobile user equipment or user device which is capable of handling MBMS and a file repair size threshold.

The UE 800 of FIG. 8 comprises a receiver 801 which is configured to receive and store a USD instance, with or without an attached file repair size threshold, in a storing unit 803, upon receiving such a USD instance via receiver 801. The receiver 801 is also configured to receive user information associated with the USD instance in a conventional manner.

The determining unit 802 is configured to recognize a request for file repair of parts of the received user information, typically in a manner which is already done in prior art solutions, and to respond to such a request by determining whether or not there is a file repair size threshold stored on the UE, i.e. whether or not the USD instance associated with the user information for which file repair is required comprise a file repair size threshold and in case there is a file repair size threshold, the determining unit 802 is configured to instruct the file repair unit to restrict use of the requested file repair method, e.g. by prohibiting file repair for the received session. The described units may e.g. be implemented in the form of one or more Application Specific Integrated Circuit (ASIC) configurations.

In case it is determined that the USD instance comprises a file repair size threshold, the determining unit 802 is configured to compare the recognized file repair size and the stored file repair size threshold and to restrict initiation of file repair on the basis of the comparison of the recognized file repair size and the stored file repair size threshold,

The determining unit 802 is typically also configured to initiate an alternative to file repair in case of file repair restriction, e.g. by instructing the receiver to apply an alternative transmission method.

According to a first embodiment, the determining unit 802 is configured to determine that there is at least one broadcast delivery timeslot available for said ongoing session, and to receive, at least parts of the required user information via the at least one broadcast delivery timeslot via the receiver 801, in case initiation of file repair is restricted. Such a determination may be based on the content of the USD instance,

According to a second embodiment, the determining unit 802 may instead be configured to switch to unicast reception and to receive, at least parts of the user information via unicast via receiver 801, in case initiation of file repair is restricted.

Alternatively, the UE 800 may be configured to combine the two alternatives above according to predefined conditions and rules, for more optimal retrieval of broadcasted or multicasted user information.

The determining unit 802 is typically configured to determine whether use a file repair size threshold is enabled or disabled, and restrict initiation of file repair, only in case use of a file repair size threshold is enabled, typically by consulting the latest received and stored USD instance. Whenever an updated USD instance, comprising an updated file repair size threshold, is received via the receiver 801, the determining unit 802 is configured to store the USD instance and the associated threshold and apply the updated threshold, i.e. to restrict use of file repair by prohibiting initiation of file repair in case the recognized file repair size exceeds the file repair size threshold, whenever a file repair request is identified.

In case an updated USD instance, comprising no file repair size threshold or an indication of no file repair size threshold, is received, the determining unit 802 is configured to also store that updated USD instance in the storing unit 803, and to apply no restriction of initiation of file repair, i.e. in such a situation the determining unit 802 is configured to handle file repair requests in a conventional manner.

According to yet another aspect, an apparatus 900 capable of transmitting user information via MBMS is configured as a software implemented apparatus comprising a processor 901, and a computer program 906, here illustrated as different modules 903a,903b,903c, comprising computer program code which is configured such that when executed on the processor 901 the processor 901 is caused to execute the method as described above with reference to FIG. 3-5. Typically the apparatus 900 also comprises a storing unit 905 for storing data used when executing the described process.

The apparatus mentioned above may also comprise a computer program product 902 comprising a computer readable storage medium on which the computer program is embodied and accessible by the processor 901.

In a corresponding way a UE may be configured to apply a computer program. More specifically, the apparatus 900 comprise a processor 1001, and a computer program 1005, here illustrated as different modules 1004a,1004b,1004c, comprising computer program code which is configured such that when executed on the processor 1001 the processor 1001 is caused to execute the method executable on a UE as described above with reference to FIG. 6. Typically the UE 1000 also comprises a storing unit 1004 for storing data used when executing the described process.

The apparatus mentioned above may also comprise a computer program product 1002 comprising a computer readable storage medium on which the computer program is embodied and accessible by the processor 1001.

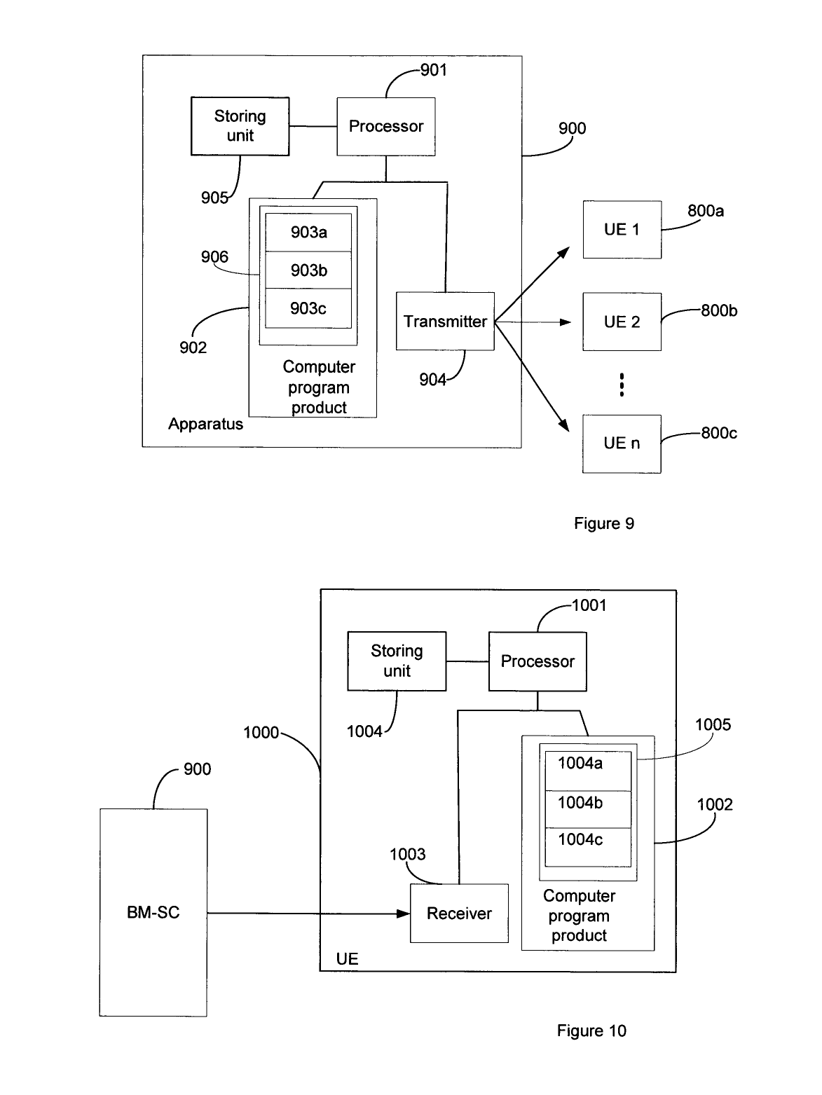

The processors 901,1001, mentioned above may be configured as any combination of one or more of a suitable central processing unit (CPU), multiprocessor, microcontroller, or digital signal processor (DSP), capable of executing computer program code stored in a storing unit or computer program product, as suggested in FIG. 9 or 10, respectively. The computer program of the apparatus 900 and the UE 1000, may be stored in a volatile or non-volatile memory, which may be e.g. an Electrically Erasable Programmable Read-only Memory, a flash memory, a disk drive A Read Only Memory (ROM) or a Random access memory (RAM).

It is also to be understood that each of the apparatus 700,900 and UEs 800,1000 of FIG. 7-10, respectively, are simplified illustrations of one way of describing interworking functional units, where, for simplicity reasons, units and/or modules which are commonly used in the present context have been omitted in case they are not essential for the understanding of the general concept described herein.

While the present document covers various alternative embodiments of the methods and apparatus as described above with reference to the disclosed figures, it is to be understood that the specific description and figures are not intended to limit the scope of the invention to the specific forms disclosed. On the contrary, the scope of the claimed invention is to be seen as including all modifications and alternative constructions thereof falling within the spirit and scope of the invention as expressed in the appended claims.

1. A User Equipment, UE, capable of receiving user information provided via Multimedia Broadcast Multicast Services, MBMS, or enhanced Multimedia Broadcast Multicast Services, eMBMS, the UE comprising:
a receiver configured to receive in a session an USD instance and associated user information, transmitted via MBMS or eMBMS, and
a determining circuit which in response to recognizing a request for file repair of missing symbols associated with the session is configured to determine whether the USD instance contained a file repair size threshold, indicative of a maximum allowed repair size, and to restrict initiation of file repair on the basis of a comparison of the size of the requested file repair and the stored file repair threshold, in case a file repair size threshold is contained in the USD instance.

2. The UE according to claim 1, wherein the determining circuit is configured to restrict initiation of file repair, in case a file repair size threshold was contained in the USD instance and in case the size of the requested file repair exceeds the stored file repair threshold.

3. The UE according to claim 1, wherein a storing circuit is configured to store a received USD instance, and wherein the determining circuit is configured to determine whether the USD instance contained a file repair size threshold by checking the content of the stored USD instance.

4. (canceled)

5. The UE according to claim 1, wherein the determining circuit is further configured to determine whether there is at least one alternative method available for the UE and the session to retrieve the missing symbols and to initiate an available one of the at least one alternative method.

6. The UE according to claim 5, wherein the determining circuit is configured to determine that there is at least one broadcast delivery timeslot available for the session, and to initiate resumed reception of the session, via the receiver, via the at least one broadcast delivery timeslot, in case initiation of file repair is restricted for the session.

7. The UE according to claim 5, wherein the determining circuit is configured to determine that unicast is available for the session, and of initiating resumed reception, via the receiver, of the session via unicast, in case initiation of file repair is restricted for the session.

8. An apparatus at a Broadcast Multicast Service Center, BM-SC, capable of transmitting user information to user equipments, UEs, via Multimedia Broadcast Multicast Services, MBMS, or enhanced Multimedia Broadcast Multicast Services, eMBMS, the apparatus comprising:
a determining circuit configured to determine whether or not to apply a restricted use of a file repair for a session, wherein
a selecting circuit is configured to select a file repair size threshold, indicative of a maximum allowed file repair size, and to insert the selected file repair size threshold into a User Service Description, USD instance, associated with the session, and
a transmitter is configured to transmit the USD instance to the UEs, in case restricted use of file repair is to be applied, to enable any of the UEs to apply a restricted use of file repair for user information associated with the USD instance, based on a comparison of a size of a requested file repair and the file repair size threshold.

9. The apparatus according to claim 8, wherein the selecting circuit is configured to insert the file repair size threshold into a schedule description metadata fragment of the USD instance.

10. The apparatus according to claim 8, wherein the selecting circuit is configured to insert the file repair size threshold into an Associated Delivery Procedure Description, ADPD metadata fragment of the USD instance.

11. The apparatus according to claim 8, wherein the selecting circuit is configured to select an updated file repair size threshold, which is inserted into an updated USD instance, by the inserting circuit and transmitted via the transmitter, in case it has been determined by the selecting circuit that the file repair size threshold should be updated for the session.

12. The apparatus according to claim 8, wherein the determining circuit is configured to initiate transmission of an updated USD instance, indicative of no file repair size threshold, via the transmitter, in case it has determined that no restricted use of file repair is to be applied for the session.

13. The apparatus according to claim 11, wherein the determining circuit is configured to determine to update the file repair size threshold on the basis of experienced and/or estimated transmission conditions.

14. A method executable in a user equipment, UE, capable of receiving user information via Multimedia Broadcast Multicast Services, MBMS, or enhanced Multimedia Broadcast Multicast Services, eMBMS, the method comprising:
receiving, in a session, a User Service Description, USD, instance, and associated user information, transmitted via MBMS or eMBMS;
recognizing a request for file repair of missing symbols associated with the session;
determining whether the USD instance contained a file repair size threshold, indicative of a maximum allowed file repair size, and
restricting initiation of file repair on the basis of a comparison of the recognized file repair size and the stored file repair size threshold, in case a file repair size threshold is contained in the USD instance.

15. The method according to claim 14, comprising the further step of:
determining to restrict initiation of file repair in case a file repair size threshold is contained in the USD instance and in case the size of the requested file repair exceeds the stored file repair threshold.

16. The method according to claim 14, comprising the further steps of:
storing a received USD instance in a storing circuit of the UE, and
determining whether the USD instance contains a file repair size threshold by checking the content of the stored USD instance.

17. The method according to claim 14, wherein the restriction of the initiation of file repair comprises prohibiting initiation of file repair in case the recognized file repair size exceeds the file repair size threshold.

18. The method according to claim 14, comprising the further steps of:
determining whether there is at least one alternative method available for the UE and the session to retrieve the missing symbols, and
initiating an available one of the at least one alternative method.

19. The method according to claim 18, wherein determining whether there is at least one alternative method available comprises:
determining whether there is at least one alternative method available for the UE and the session to retrieve the missing symbols, and
initiating resumed reception of the session, via the at least one broadcast delivery timeslot, in case initiation of file repair is restricted for the session.

20. The method according to claim 18, wherein determining whether there is at least one alternative method available comprises:
determining that unicast is available for the session, and
initiating resumed reception of the session, via unicast, in case initiation of file repair is restricted for the session.

21. A computer program product comprising a non-transitory computer readable medium storing computer program code, the computer program code being configured such that when executed by a processor it causes the processor to implement the method according to claim 1.

22. (canceled)

23. A method executable in an apparatus at a Broadcast Multicast Service Center, BM-SC, capable of transmitting user information via Multimedia Broadcast Multicast Services, MBMS, or enhanced Multimedia Broadcast Multicast Services, eMBMS to user equipments capable of receiving the user information, the method comprising:
determining whether or not to apply a restricted use of a file repair for a session, wherein in case restricted use of file repair is to be applied for the session, the method further comprises:
selecting a file repair size threshold, indicative of a maximum allowed file repair size,
inserting the selected file repair size threshold into a User Service Description, USD instance, associated with the session, and
ectransmitting the USD instance to the UEs, in case restricted use of file repair is to be applied, thereby enabling any of the UEs to apply a restricted use of file repair for user information associated with the USD instance, based on a comparison of a size of a requested file repair and the file repair size threshold.

24. The method according to claim 23, wherein the file repair size threshold is inserted into a schedule description metadata fragment of the USD instance.

25. The method according to claim 23, wherein the file repair size threshold is inserted into an Associated Delivery Procedure Description, ADPD metadata fragment of the USD instance.

26. The method according to claim 23, comprising the further steps of:
determining that an updating of the file repair size threshold is required, and repeating said steps.

27. The method according to claim 23, comprising the further steps of:
assembling and transmitting an updated USD instance, indicative of no file repair size threshold, in case it has determined that no restricted use of file repair is to be applied for the session.

28. The method according to claim 23, wherein the step of selecting file repair size threshold is executed on the basis of experienced and/or estimated transmission conditions.

29. A computer program product comprising a non-transitory computer readable medium storing computer program code, the computer program code being configured such that when executed by a processor it causes the processor to implement the method according to claim 23.

30. (canceled)
